(19) United States
(12) Patent Application Publication
(10) Pub. No.: US 2012/0031307 A1
(43) Pub. Date: Feb. 9, 2012

(54) SYSTEM AND METHOD FOR MANUFACTURING CEMENT CLINKER UTILIZING WASTE MATERIALS

(76) Inventor: John Graham Whellock, Castle Rock, CO (US)

(21) Appl. No.: 12/997,549

(22) PCT Filed: Aug. 6, 2010
(86) PCT No.: PCT/US10/44746

§ 371 Date: Dec. 10, 2010

(51) Int. Cl. C04B 18/04; C04B 18/06; F23G 5/08; F23G 5/20; C04B 7/44; F27B 7/20

(52) U.S. Cl. 106/707; 432/111; 432/117; 110/244; 106/638; 110/246; 106/705; 106/792; 106/800

(57) ABSTRACT

Techniques are generally described for producing cement clinker that includes forming cement clinker in a kiln, heating waste additives, and applying the heated waste additives to the cement clinker in the kiln. Additionally, examples are generally described that include an apparatus for producing cement clinker that includes a kiln in which cement clinker is formed and a device having an opening positioned inside the kiln which provides heated waste additives to the kiln for application to the cement clinker. An example device for applying waste additives to cement clinker includes an eductor configured to receive waste additives and transport air in which the waste additives are pneumatically entrained, and includes a lance coupled to the eductor and configured to receive the pneumatically entrained waste additives and receive a support gas that reacts with the waste additives and heats the same for application to the cement clinker.

### BACKGROUND

Other than direct power production from fossil fuels, the cement industry is one of the world's largest sources of carbon dioxide (green house gas). The emission of carbon dioxide in the process is generally given as one ton per ton of cement. The industry in North America makes use of large cement kilns that are fired counter-current to the flow of raw materials to form cement clinker. The cement clinker is ground to produce powdered cement. Various waste fuels are used but principally coal is fired to heat the kiln.

Raw materials used in the formation of cement clinker include limestone, alumina and silica from various feedstocks in controlled ratios. The resulting product is calcium alumino-silicate. Calcination of limestone itself leads to high quantities of carbon dioxide by the breakdown of carbonates into oxides. Production of low or lower carbon dioxide emissions during cement production is desirable. So called “green cement” may take the form of altered chemistry or reduced fuel consumption. Implementation of new technology is resisted generally by the industry due to the investment in manufacturing equipment.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

In the drawings:

FIG. 1 is a schematic diagram of an example system for producing cement clinker;

FIG. 2 is a schematic diagram of an example apparatus for providing heated additives to a kiln for application to cement clinker; and

FIG. 3 is a flow diagram for an example system of producing cement clinker; all arranged in accordance with at least some examples of the present disclosure.

### SUMMARY

Techniques are generally described that include methods, devices, and/or apparatus.

Some example methods may include feeding raw materials into a kiln, forming cement clinker from the raw materials in the kiln, heating waste additives, and applying the heated waste additives to the cement clinker in the kiln.

Some example devices may include an eductor and a lance. The eductor is configured to receive waste additives and is further configured to receive transport air in which waste additives are pneumatically entrained. The lance is coupled to the eductor and is configured to receive the pneumatically entrained waste additives. The lance is further configured to receive a support gas to react with the waste additives and heat the same and configured to apply the heated waste additives to the cement clinker.

Some example apparatus include a kiln and a device. Cement clinker is formed in the kiln and the device is configured to have an opening positioned inside the kiln and to provide heated waste additives to the kiln for application to the cement clinker.

### DETAILED DESCRIPTION

The following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are implicitly contemplated herein.

This disclosure is drawn, inter alia, to methods, systems, devices, and/or apparatus generally related to manufacturing cement clinker. Techniques are generally described for producing cement clinker that includes forming cement clinker in a kiln, heating waste additives, and applying the heated waste additives to the cement clinker in the kiln. Additionally, examples are generally described that include an apparatus for producing cement clinker that includes a kiln in which cement clinker is formed and a device having an opening positioned inside the kiln which provides heated waste additives to the kiln for application to the cement clinker. An example device for applying waste additives to cement clinker includes an eductor configured to receive waste additives and transport air in which the waste additives are pneumatically entrained, and includes a lance coupled to the eductor and configured to receive the pneumatically entrained waste additives and receive a support gas that reacts with the waste additives and heats the same for application to the cement clinker.

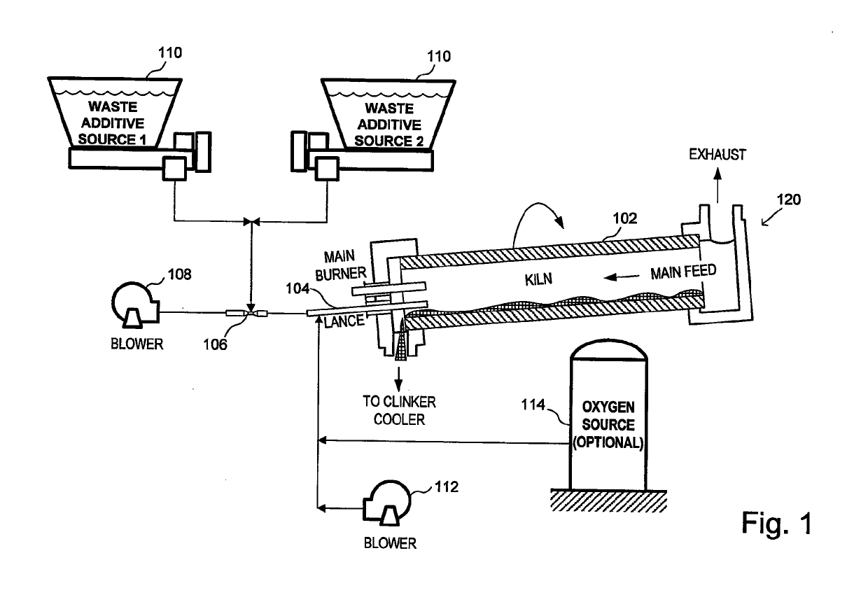

FIG. 1 is a schematic diagram of an example system for producing cement clinker. The system includes a cement kiln 102 in which cement clinker can be formed. The cement kiln 102 is illustrated in FIG. 1 as a rotary kiln, but other types of kilns may be used as well, for example, vertical shaft kilns, kilns having dry or wet process design for feed handling, and kilns having preheaters (e.g., multiple preheater cyclones for shorter kiln length), and other kilns now known or later developed. The system further includes a device 104 to provide heated waste additives for application to cement clinker formed in the kiln 102. In the example shown in FIG. 1, the device 104 has an elongated configuration with a portion that extends into the kiln 102. The device 104 having an elongated configuration of the device 104 can be generally referred to as a “lance.” Other configurations for the device 104, however, can be used as well. Operatively coupled to the device 104 is eductor 106 that receives transport air from blower 108 and waste additives from waste additive source(s) 110. FIG. 1 illustrates two waste additive sources 110, but fewer or greater waste additive sources can be used as well. The device 104 is further operatively coupled to receive support gas from blower 112. An example of a support gas is air. Other types of support gas may be used as well. Oxygen from optional oxygen source 114 may be provided to the device 104 in addition or alternatively to the support gas.

In operation, cement clinker is formed in the kiln 102 from raw materials fed into a first end 120 of the kiln 102. Examples of the raw materials include limestone, clay, cement rock, shale, sand, and other materials containing calcium, silicon, and aluminum. As the kiln 102 rotates, and due to the downward slope of the kiln 102, the raw materials move from the first end 120 to a second end 122, which has a main burner providing heat to the kiln 102. During the movement through the kiln 102, the raw materials react due to the increasing temperature along the length of the kiln 102. Proximate the second end 122, the raw materials are sintered to form cement clinker, which falls out through an opening at the second end 122 of the kiln 102 for cooling. Prior to leaving the kiln 102, however, heated waste additives are applied to the cement clinker by the device 104. As will be described in more detail below, the heated waste additives are fired onto the bed of cement clinker. As will also be described in more detail below, the waste additives heated and applied by the device 104 can be waste materials that would otherwise require disposal and/or create an environmental hazard.

Waste materials containing fuel value such as carbon are utilized with air/oxygen in the device 104 to augment conventional kiln production. Utilizing the heat value in the component materials with a proportion of oxygen accomplishes fusion of the product to the cement clinker in the kiln 102. Example materials such as flyash containing carbon and additional waste lime or dolomite fines from calcining operations fuse to the clinker in the kiln 102. The waste materials such as coal burning power plant flyash which is too high in ammonia or carbon for sale is fired with or without pre-calcined lime or dolomite fines or waste cement kiln dust. These types of waste materials can be utilized and often have credits attached to their disposal. Additionally, heat liberated in the reaction can mitigate the overall fuel required for the cement clinker manufacturing process.

Waste materials may generally fall in the pseudowollastonite-gehlenite-anorthite fields—having a reasonably compatible melting point and corresponding with compositions of [SiO2+Al2O3]/CaO ranging from 1 to 2.5. The proportion of waste material added to an existing cement kiln operation can be a small or a large contribution depending on the chemistry of the product desired. Typically a glassy type product is made unlike the more crystalline formation of cement clinker. The heat of reaction is sufficient to produce the required fused product, which is fired at the cement clinker near the discharge zone of the kiln 102.

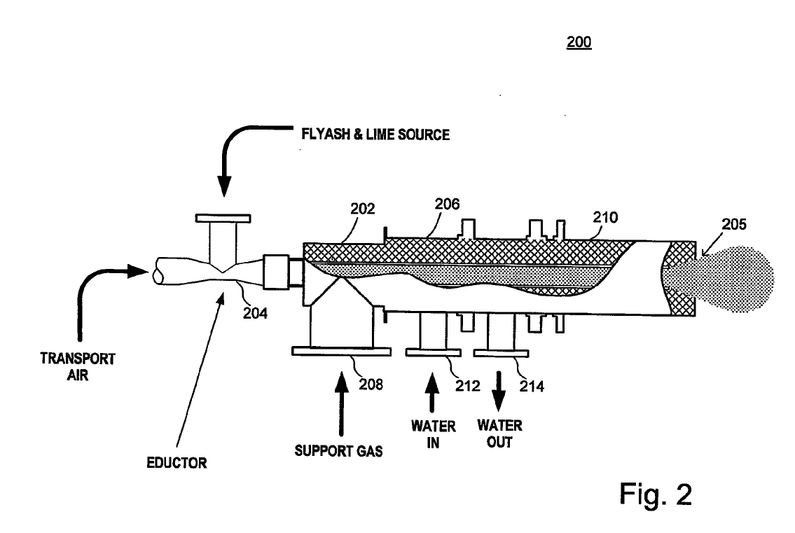

FIG. 2 is a schematic diagram of device 200 according to an example for providing heated waste additives to a kiln for application to cement clinker. The device 200 can be used for the device 104 in the example system shown in FIG. 1. The device 200 includes a waste additive supply conduit 202 operatively coupled to an eductor 204. The eductor 204 receives transport air and waste additives, for example, waste materials, and provides pneumatically entrained waste additives to the waste additive supply conduit 202. The pneumatically entrained waste additives may be provided in a dense-phase flow. The waste additive supply conduit 202 directs the waste additives to an opening 205 of the device 200 from which the waste additives are injected into a kiln. In some examples, the waste additive supply conduit 202 includes a replaceable sleeve (not shown) to provide wear protection, for example, a hardened and/or ceramic sleeve inside the waste additive supply conduit 202. The device 200 further includes a gas supply conduit 206 that receives a support gas through an inlet 208 and directs it to the opening 205 to react with the waste additives exiting from the waste additive supply conduit 202 and heat the waste additives for application to the cement clinker. The heated waste additives may form a glassy amorphous structure on the cement clinker. For example, the support gas directed by the gas supply conduit 206 to the opening 205 causes the blown waste additives exiting from the waste additive supply conduit 202 to combust. The waste additives, heated by the combustion reaction, can be applied to cement clinker.

A non-limiting example is provided to illustrate a reaction making a glassy product. For one ton of flyash, including:

8.57 moles SiO2(s)

2.207 moles Al2O3(s)

1.070 moles of CaO(s)

16.651 moles of unburned C

A reaction is effected at 1500 degrees C. with 10.967 moles of CaO (s) (reject lime fines), 8.269 moles of generated oxygen and 45.835 moles of air. The products are a glassy slag with 8.571 moles of SiO2(l), 2.207 moles of Al2O3(l) and 12.037 moles of CaO(l) with a liquidus of ˜1400 degrees C. in the pseudowollastonite-anorthite region. The products of combustion contain 16.651 moles of carbon dioxide, plus nitrogen and some excess oxygen. Here (s) and (l) designated solid and liquid states, respectively.

An example of a support gas may be oxygen or another example is a mixture of air and oxygen. However, oxygen may not be necessary because of the calorific content of the waste additives. Where both air and oxygen are utilized as the support gas, the air and oxygen may be premixed when provided to the device 200. In another example, the device 200 includes an additional conduit (not shown) to carry a different support gas than that provided by the gas supply conduit 206. In this manner, the different gases may be mixed upon exiting the respective conduit at the opening 205 in order to provide tip mixing of the different gases.

The device 200 further includes a cooling conduit 210. The cooling conduit 210 provides cooling to or insulates the device 200. The cooling conduit 210 is shown in FIG. 2 to surround the waste additive supply and gas supply conduits 202, 206. Other configurations for the cooling conduit 210 may be used as well. The cooling conduit 210 is shown in FIG. 2 as also coupled to receive water through inlet 212 and expel water through outlet 214. As a result, water can be circulated in the cooling conduit 210 in the configuration shown in FIG. 2 to provide cooling of the device 200. Fluids other than water may also be used. In other examples, no fluid is used in the cooling conduit 210.

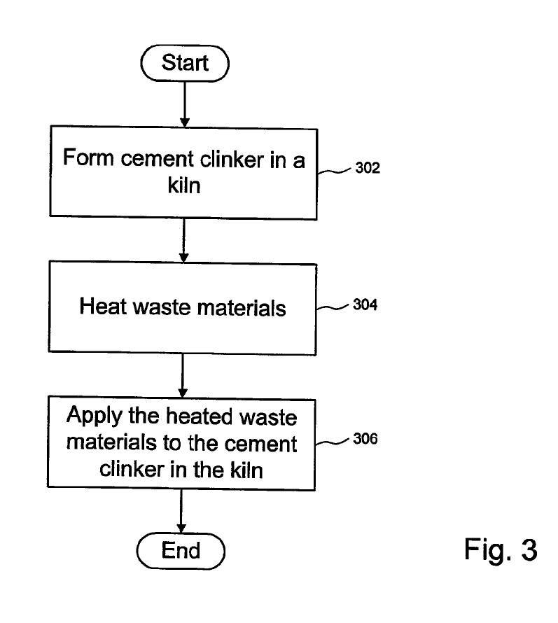

FIG. 3 is a flow diagram for producing cement clinker. At step 302 cement clinker is formed in a kiln. An example of a kiln for forming cement clinker is a rotary kiln. Waste additives are heated at step 304 and the heated waste additives are applied to the cement clinker in the kiln at step 306. Examples of waste materials that can be used as waste additives include flyash, pre-calcined lime, dolomite fines, cement kiln dust, waste coal fines, zeolite fines, or combinations thereof. The waste material would otherwise require disposal and possibly present an environmental hazard. In some examples, the waste additives are heated by combusting the waste additives. Oxygen may be added to the process to facilitate combustion.

After accounting for some carbon dioxide produced in the reaction and the oxygen CO2 equivalent there may be a net reduction in overall carbon dioxide produced for each additional ton of cement clinker created. For example, 0.9 tons of carbon dioxide per ton of additional clinker cement may be saved by the process. The following is an example illustrating various hypothetical benefits of the process, and is not intended to limit the scope of the invention. Consider a cement plant producing two million tons per year of cement has local access to 200,000 tons per year of off-spec power plant flyash. The flyash has ca. 20% residual carbon and is typically dumped at some cost to the power plant. Assume a ratio of approximately 0.71 tons of ash to 0.43 tons of waste pre-calcined lime containing fines can be added to 10 tons of cement clinker production. Utilizing a calorific value for the contained carbon in the flyash of 31.395 MJ/kg, the ash is fired to fusion point (approximately 1500 degrees C.) in conjunction with 1.3 tons of air per ton of additional cement clinker and with 0.19 tons of oxygen addition. Carbon credits are accounted for at $15/t. Credits can be obtained on the flyash of about $10/t. The additional cement produced (10% extra annual production) attracts a cement price of $80/t and the reduction in fuel consumed is 0.4 GJ/t of clinker. The operating costs are assumed to be: $60/t for lime fines delivered (an example case, as it could be a credit), $10/t for the flyash transport, plus labor, oxygen, compression power, maintenance and depreciation.

More generally, in the previous non-limiting hypothetical example, the Annual Net

Revenue (ANR) can be derived from:

ANR=[15×(T−2.498×C)]+(FA×10)+(T×80)+(C×31.395×4)−(T−61.056)

where T is the total additional clinker, T=(FA−C+L), FA is flyash, C is Carbon in FA, and L is Lime addition or CKD, and

[15×(T−2.498×C)] represents carbon credits ($15/ton) from using the flyash,

(FA×10) represents credits ($10/ton) for use of the flyash,

(T×80) represents revenue gain from the augmented cement production ($80/ton) resulting from the waste materials,

(C×31.395×4) represents reduction in fuel costs due to the fuel value of carbon in the flyash, and

(T×61.056) represents an annual operating cost for using the waste materials.

Hence the following economic benefits may be calculated:

Carbon credit @ $15/ton 129,372 tpa of CO2 equivalent: $1,940,580

Flyash annual credit: $1,413,420

Revenue gain from augmented cement production: $16,000,000

Reduction in fuel costs: $3,549,946

Total Increase in Gross Revenue: $22,903,946

Annual operating cost: $12,211,266

Annual Net Revenue (ANR): $10,692,679

In summary, producing cement clinker according to embodiments of the invention may result in CO2 emission reductions per ton of cement clinker, and may offer a way of augmenting the production from a cement kiln where there is a local source of high carbon flyash, waste coal fines, cement kiln dust, zeolite fines or other waste materials. The silica, alumina and calcia components contribute to the cement clinker production and energy may be recovered and the fuel requirement per ton of cement clinker produced is lowered.

The present disclosure is not to be limited in terms of the particular examples described in this application, which are intended as illustrations of various aspects. Many modifications and examples can may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two co so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

1. A method for producing cement clinker with waste additives, comprising:
feeding raw materials into a kiln;
forming cement clinker from the raw materials in the kiln;
heating the waste additives; and
after the cement clinker is formed applying the heated waste additives to the cement clinker in the kiln.

2. The method of claim 1 wherein heating the waste additives comprises combusting the waste additives.

3. The method of claim 1 wherein heating the waste additives comprises adding oxygen during the heating of the waste additives.

4. The method of claim 1 wherein heating the waste additives comprises conveying the waste additives in a gas flow into a heated end of the kiln.

5. The method of claim 1 wherein heating the waste additives comprises an exothermic reaction and the method of claim 1 further comprises recovering waste heat from the exothermic reaction and using the same for supplementing heating of the kiln.

6. The method of claim 4 wherein conveying the waste additives in a gas flow comprises conveying the waste additives in air.

7. The method of claim 4 wherein conveying the waste additives in a gas flow comprises conveying the waste additives in a dense-phase flow.

8. The method of claim 1 wherein heating the waste additives comprises heating waste additives including at least one of flyash, pre-calcined lime, dolomite fines, cement kiln dust, waste coal fines, zeolite fines, or combinations thereof.

9. The method of claim 1 wherein heating the waste additives comprises releasing less carbon dioxide per weight of applied waste additives to the cement clinker than from forming cement clinker from the raw materials in the kiln thereby reducing the carbon dioxide emission per weight of cement clinker produced.

10. The method of claim 1 wherein applying the heated waste additives to the cement clinker in the kiln comprises applying the heated waste additives to the cement clinker to form a glassy amorphous structure on the cement clinker.

11. The method of claim 1 wherein forming cement clinker in the kiln comprises firing fused waste additives at the cement clinker in the kiln.

12. The method of claim 1 wherein forming cement clinker in a kiln comprises forming cement clinker in a rotary kiln.

13. An apparatus for producing cement clinker with waste additives, comprising:
a kiln in which the cement clinker is formed; and
a device configured to have an opening positioned inside the kiln and after the cement clinker if formed provide the heated waste additives to the kiln for application to the cement clinker.

14. The apparatus of claim 13 wherein the device configured to have an opening positioned inside the kiln comprises a lance extending into the kiln and configured to fire the heated waste additive onto the cement clinker.

15. The apparatus of claim 13 wherein the device configured to have an opening positioned inside the kiln comprises:
a waste additive supply conduit configured to provide waste additives pneumatically entrained in a transport gas and heat the pneumatically entrained waste additives for application to the cement clinker; and
a cooling conduit covering at least a portion of the waste additive supply conduit and configured to cool at least a portion of the waste additive supply conduit.

16. The apparatus of claim 15 wherein the device configured to have an opening positioned inside the kiln further comprises a gas supply conduit configured to provide a gas proximate an opening of the waste additive supply conduit.

17. The apparatus of claim 16 wherein the gas supply conduit comprises a gas supply conduit configured to provide at least oxygen proximate the opening of the waste additive supply conduit.

18. The apparatus of claim 17 wherein the gas supply conduit further comprises an air supply conduit configured to provide air proximate the opening of the waste additive supply conduit.

19. The apparatus of claim 16 wherein the gas supply conduit is configured to provide a gas to combust the waste additives entrained in the transport gas.

20. The apparatus of claim 13 wherein the kiln comprises a rotary cement kiln.

21. The apparatus of claim 20 wherein the device configured to have an opening positioned inside the kiln comprises a device having an opening positioned at a heated end of the rotary cement kiln.

22. The apparatus of claim 13 wherein the device configured to have an opening positioned inside the kiln is configured to apply the heated waste additives to form a glassy amorphous structure on the cement clinker.

23. The apparatus of claim 13 wherein the device configured to have an opening positioned inside the kiln comprises a plurality of conduits configured to provide air entrained waste additives and a support gas to combust the waste additives in the kiln.

24. The apparatus of claim 23 wherein the device configured to have an opening positioned inside the kiln comprises at least one annular conduit.

25. A device for applying waste additives to cement clinker, comprising:
an eductor configured to receive waste additives and further configured to receive transport air in which the waste additives are pneumatically entrained; and
a lance coupled to the eductor and configured to receive the pneumatically entrained waste additives and configured to receive a support gas to react with the waste additives and heat the same, the lance further configured to apply, after the cement clinker is formed, the heated waste additives to the cement clinker.

26. The device of claim 25 wherein the lance comprises a lance configured to receive the support gas to combust the waste additives.

27. The device of claim 26 wherein the lance is configured to receive at least oxygen.

28. The device of claim 25 wherein the lance comprises:
a first conduit coupled to the eductor to receive the pneumatically entrained waste additives and having an opening from which the waste additives are expelled;
a second conduit configured to receive the support gas and provide the same proximate the opening of the first conduit to react with the waste additives; and
a third conduit configured to insulate at least a portion of the first conduit.

29. The device of claim 28 wherein the third conduit is configured to circulate water.

30. The device of claim 28 wherein the first conduit includes a ceramic sleeve.
